(19) United States
(12) Patent Application Publication
(10) Pub. No.: US 2021/0146689 A1
(43) Pub. Date: May 20, 2021

(54) LIQUID EJECTING APPARATUS AND MAINTENANCE METHOD OF LIQUID EJECTING APPARATUS

(71) Applicant: SEIKO EPSON CORPORATION, Tokyo (JP)

(72) Inventor: Hiroki MATSUOKA, Azumino-shi (JP)

(21) Appl. No.: 17/087,783

(22) Filed: Nov. 3, 2020

(30) Foreign Application Priority Data
Nov. 14, 2019 (JP) 2019-206037

(51) Int. Cl. B41J 2/165

(52) U.S. Cl. CPC B41J 2/16535

(57) ABSTRACT

A liquid ejecting apparatus includes a liquid ejecting portion configured to eject a liquid supplied through a common flow path, from a plurality of nozzles that are arranged on a nozzle surface and form a nozzle row, a wiping mechanism that includes a wiping member having absorptivity for absorbing the liquid and is configured to wipe the nozzle surface, and a control portion that drives the wiping mechanism during a wiping operation of wiping the nozzle surface by the wiping member or before the wiping operation after a discharge operation of discharging the liquid from the nozzle, and performs a stop operation of stopping the wiping member for a predetermined time at a position at which the wiping member comes into contact with the liquid that swells to cover the nozzle or with the nozzle.

The present application is based on, and claims priority from JP Application Serial Number 2019-206037, filed Nov. 14, 2019, the disclosure of which is hereby incorporated by reference herein in its entirety.

### BACKGROUND

### 1. Technical Field

The present disclosure relates to a liquid ejecting apparatus and a maintenance method of the liquid ejecting apparatus.

### 2. Related Art

As an example of a liquid ejecting apparatus, an ink jet printer that performs printing of characters or images by ejecting an ink as an example of a liquid, onto a medium such as paper is known in the related art. For example, JP-A-2009-178889 discloses an ink jet printer that includes a tank-side liquid chamber that stores an ink supplied from an ink tank, a head-side liquid chamber that stores the ink to be supplied to an ink jet head, an ink path in which an ink flows from the tank-side liquid chamber into the head-side liquid chamber, a variable pressure chamber capable of changing the pressure in the chamber, a flexible film being a pressure transfer portion that transfers pressure in the variable pressure chamber to the head-side liquid chamber, and a valve that closes the ink path when the pressure in the tank-side liquid chamber becomes higher than the pressure in the variable pressure chamber by a preset pressure difference or larger.

The ink jet printer includes a pressure setting portion that changes the pressure in the variable pressure chamber. For example, the pressure setting portion sets the pressure in the variable pressure chamber during cleaning of performing cleaning of the nozzles of the ink jet head to be higher than the pressure during printing of performing printing in the ink jet printer.

However, the liquid ejecting apparatus in JP-A-2009-178889 performs cleaning of discharging the liquid supplied to a liquid ejecting portion from the nozzle. Thus, the liquid ejecting apparatus has a problem that ejection of the liquid from the nozzles after that becomes unstable by pressure in the liquid ejecting portion or a liquid supply flow path after the discharge of the liquid from the nozzle is stopped.

### SUMMARY

A liquid ejecting apparatus includes a liquid ejecting portion that is configured to eject a liquid supplied through a common flow path, from a plurality of nozzles that are arranged on a nozzle surface and form a nozzle row, a wiping mechanism that includes a wiping member and is configured to wipe the nozzle surface, and a control portion that drives the wiping mechanism during a wiping operation of wiping the nozzle surface by the wiping member or before the wiping operation after a discharge operation of discharging the liquid from the nozzle, and performs a stop operation of stopping the wiping member for a predetermined time at a position at which the wiping member comes into contact with the liquid that swells to cover the nozzle or with the nozzle.

A maintenance method of a liquid ejecting apparatus including a liquid ejecting portion that is configured to eject a liquid supplied through a common flow path, from a plurality of nozzles that are arranged on a nozzle surface and form a nozzle row, a wiping member that is configured to wipe the nozzle surface, the method includes performing a stop operation of stopping the wiping member for a predetermined time at a position at which the wiping member comes into contact with the liquid that swells to cover the nozzle or with the nozzle, during a wiping operation of wiping the nozzle surface by the wiping member or before the wiping operation after a discharge operation of discharging the liquid from the nozzle.

### BRIEF DESCRIPTION OF THE DRAWINGS

FIG. 1 is a schematic diagram illustrating a liquid ejecting apparatus according to a first embodiment.

FIG. 2 is a schematic plan view illustrating a printing region and a non-printing region.

FIG. 3 is a side view illustrating a wiping mechanism.

FIG. 4 is a schematic diagram illustrating a pressure adjusting mechanism and a supply mechanism in a state where an on-off valve is closed.

FIG. 5 is a schematic diagram illustrating a plurality of pressure adjusting mechanisms and pressure adjusting portions.

FIG. 6 is a flowchart illustrating a maintenance method.

FIG. 7 is a schematic diagram illustrating a discharge operation.

FIG. 8 is a schematic diagram illustrating a stop operation.

FIG. 9 is a schematic diagram illustrating a finish wiping operation.

FIG. 10 is a side view illustrating a wiping mechanism of a liquid ejecting apparatus according to a second embodiment.

FIG. 11 is a flowchart illustrating a maintenance method.

FIG. 12 is a schematic diagram illustrating a stop operation.

### DESCRIPTION OF EXEMPLARY EMBODIMENTS

### 1. First Embodiment

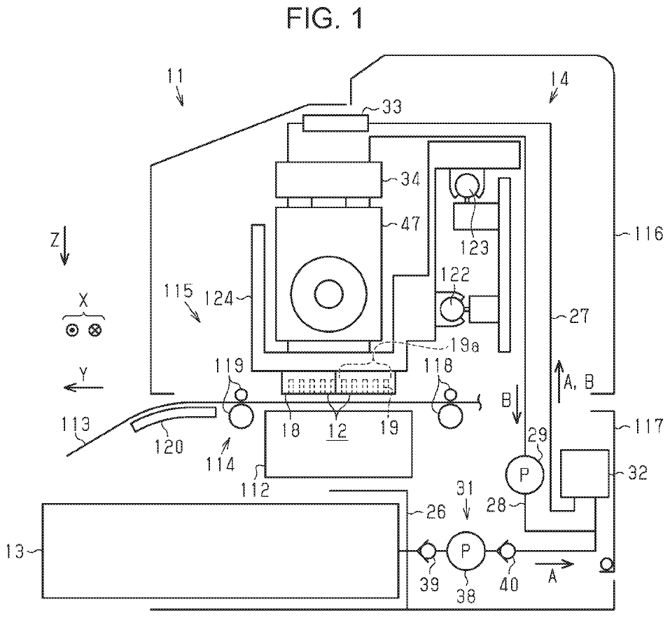

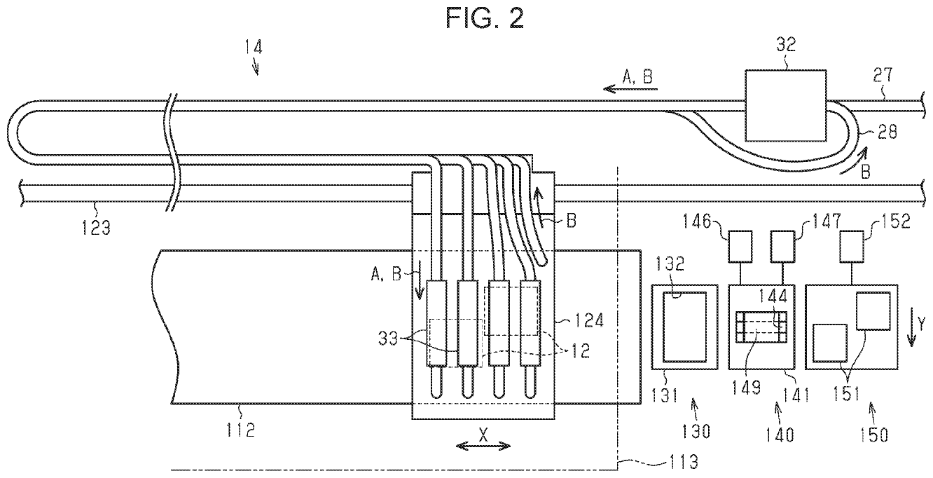

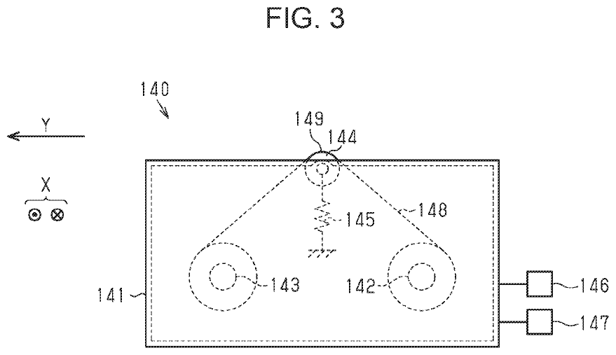

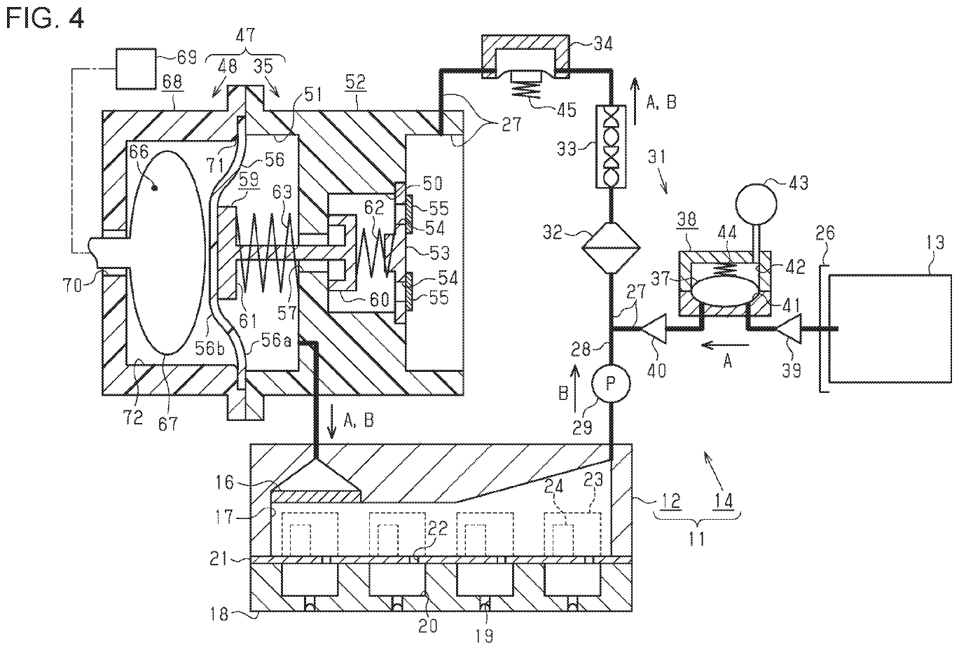

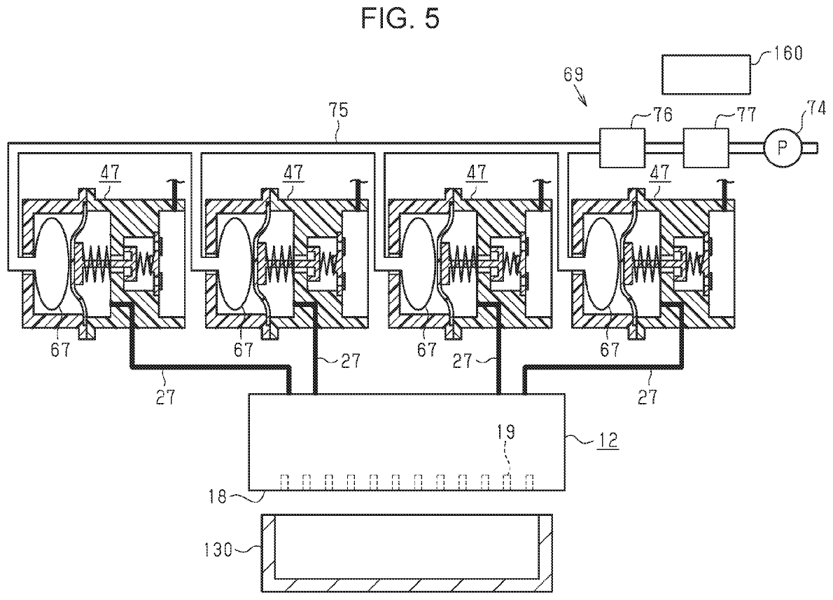

FIG. 1 is a schematic diagram illustrating a liquid ejecting apparatus according to a first embodiment. FIG. 2 is a schematic plan view illustrating a printing region and a non-printing region. FIG. 3 is a side view illustrating a wiping mechanism. FIG. 4 is a schematic diagram illustrating a pressure adjusting mechanism and a supply mechanism in a state where an on-off valve is closed. FIG. 5 is a schematic diagram illustrating a plurality of pressure adjusting mechanisms and pressure adjusting portions.

Firstly, an overall configuration of a liquid ejecting apparatus 11 according to a first embodiment will be described with reference to FIGS. 1 to 5. The liquid ejecting apparatus 11 according to the first embodiment is an ink jet printer that performs printing of characters and images by ejecting an ink as an example of a liquid, onto a medium 113 such as paper.

As illustrated in FIG. 1, the liquid ejecting apparatus 11 includes a liquid ejecting portion 12 that ejects liquid, and a supply mechanism 14 that supplies the liquid from a liquid supply source 13 to the liquid ejecting portion 12. The liquid ejecting apparatus 11 further includes a support stand 112 disposed at a position facing the liquid ejecting portion 12, a transporting portion 114 that transports a medium 113 in a transport direction Y, and a printing portion 115 that performs printing by ejecting a liquid onto a medium 113 while moving the liquid ejecting portion 12 in a scanning direction X.

The support stand 112 extends in a width direction of the medium 113, which is a direction perpendicular to the transport direction Y of the medium 113. The width direction of the medium 113 corresponds to the scanning direction X. The support stand 112, the transporting portion 114, and a printing portion 115 are assembled in a main body 116 including a housing, a frame, and the like. A cover 117 is provided on the main body 116 to be openable and closable.

The transporting portion 114 includes transport roller pairs 118 and 119 respectively disposed upstream and downstream of the support stand 112 in the transport direction Y, and a guide plate 120 that guides the medium 113 disposed downstream of the transport roller pair 119. When the transport roller pairs 118 and 119 are driven by a transport motor to rotate while nipping the medium 113, the medium 113 is transported along the surface of the support stand 112 and the surface of the guide plate 120 while being supported by the support stand 112 and the guide plate 120.

The printing portion 115 includes guide shafts 122 and 123 extending in the scanning direction X, and a carriage 124 capable of reciprocating in the scanning direction X while being guided by the guide shafts 122 and 123. The carriage 124 moves by driving of a carriage motor. Two liquid ejecting portions 12 are attached to a lower end portion of the carriage 124 which is an end portion on the vertical direction Z side. The two liquid ejecting portions 12 are disposed to be separated from each other by a predetermined distance in the scanning direction X and shifted from each other by a predetermined distance in the transport direction Y. Each liquid ejecting portion 12 ejects the liquid from a plurality of nozzles 19 that are arranged on the nozzle surface 18 and form a nozzle row 19a. The number of liquid ejecting portions 12 may be one or equal to or more than three.

As illustrated in FIG. 2, a flushing mechanism 130, a wiping mechanism 140, and a cap mechanism 150 are provided in a non-printing region being a region in which the liquid ejecting portion 12 does not face the transported medium 113 in the scanning direction X.

The flushing mechanism 130 includes a liquid receiving portion 131 that receives the liquid ejected by flushing from the nozzle 19 of the liquid ejecting portion 12. The liquid receiving portion 131 has a box shape having an opening 132 toward a moving region of the carriage 124. The flushing is an operation of forcibly discharging the liquid from the nozzle 19 regardless of printing for the purpose of preventing and eliminating clogging and the like of the nozzle 19.

As illustrated in FIG. 3, the wiping mechanism 140 includes a wiping member 148 having absorptivity for absorbing a liquid, and is configured to enable wiping of the nozzle surface 18 of the liquid ejecting portion 12 in a wiping direction in a wiping operation. The wiping direction is the transport direction Y along the nozzle row 19a or a direction opposite to the transport direction Y.

The wiping mechanism 140 has a box-like housing 141. In the housing 141, an unwinding portion 142 and a winding portion 143 which are arranged with being spaced in the wiping direction, a pressing portion 144 that presses the band-like wiping member 148 located between the unwinding portion 142 and the winding portion 143 toward the nozzle surface 18, and a pushing member 145 that applies a pressing force to the pressing portion 144 are provided. The wiping mechanism 140 includes a first wiper driving portion 146 driven when the housing 141 is moved forward and backward, and a second wiper driving portion 147 driven when a distance from the nozzle surface 18 in the vertical direction Z is adjusted.

The unwinding portion 142, the winding portion 143, and the pressing portion 144 are rollers which are rotatably supported by the housing 141 such that the axial directions thereof are the same. A portion of the pressing portion 144 is exposed from the opening of the housing 141. The wiping member 148 is a so-called cloth wiper, and the band-like wiping member 148 is wound around the unwinding portion 142 in a roll shape. The winding portion 143 rotationally drives to wind the wiping member 148 fed from the unwinding portion 142. Although the pressing portion 144 has been described as a roller, the pressing portion 144 may be a rubber protrusion member or a resin member such as urethane capable of pressing the nozzle surface 18.

In this manner, in the wiping mechanism 140, the wiping member 148 fed from the unwinding portion 142 is wound around the pressing portion 144 and is wound around the winding portion 143. Thus, if the first wiper driving portion 146 and the second wiper driving portion 147 are driven in a state in which the carriage 124 is moved such that the liquid ejecting portion 12 is located above the wiping mechanism 140, the nozzle surface 18 is wiped by moving the wiping portion 149 wound around the pressing portion 144 in the wiping member 148 relative to the liquid ejecting portion 12. After the wiping portion 149 absorbs the liquid by wiping the nozzle surface 18, a portion of the wiping member 148, that absorbs the liquid, is wound by driving and rotating the winding portion 143. In this manner, the wiping member 148 having the wiping portion 149 that has absorbed the liquid is replaced with a wiping member 148 in which the liquid is not absorbed.

As illustrated in FIG. 2, the cap mechanism 150 includes two caps 151 having a rectangular box shape with a bottom, which covers the plurality of nozzles 19 opening in the nozzle surfaces 18 of the two liquid ejecting portions 12, and a cap drive portion 152 that moves the caps 151 up and down. So-called capping in which the two caps 151 respectively abut on the nozzle surfaces 18 of the two liquid ejecting portions 12 to cover all nozzles 19 is performed in a manner that the cap drive portion 152 is driven to raise the two caps 151 in a state where the two liquid ejecting portions 12 are moved at positions respectively facing the two caps 151. That is, each cap 151 is capable of capping a region including all the nozzles 19 on the nozzle surface 18 of each liquid ejecting portion 12.

Next, the liquid ejecting portion 12 will be described in detail with reference to FIG. 4. The liquid ejecting portion 12 is configured to be capable of ejecting the liquid supplied through the common liquid chamber 17 as the common flow path, from the plurality of nozzles 19 formed on the nozzle surface 18.

The liquid ejecting portion 12 includes an ejection-portion filter 16 that captures air bubbles or foreign matters in the liquid, and a common liquid chamber 17 that stores the liquid that has passed through the ejection-portion filter 16. The liquid ejecting portion 12 includes a plurality of pressure chambers 20 as liquid chambers provided between the plurality of nozzles 19 and the common liquid chamber 17. A portion of the wall surface of the pressure chamber 20 is formed by a vibration plate 21. The common liquid chamber 17 and the pressure chamber 20 communicate with each other through a communication hole 22. That is, the common liquid chamber 17 communicates with the plurality of nozzles 19 forming the nozzle row 19a through the pressure chamber 20. The actuator 24 accommodated in an accommodation room 23 is provided at a position different from the common liquid chamber 17 on a surface on an opposite side of a portion of the vibration plate 21, which faces the pressure chamber 20.

In the first embodiment, the actuator 24 includes a piezoelectric element that contracts when a drive voltage is applied to the piezoelectric element. When the vibration plate 21 is deformed by contraction of the actuator 24 in response to the application of the drive voltage, and then the application of the drive voltage to the actuator 24 is released, the liquid in the pressure chamber 20 having a changed volume is ejected from the nozzle 19 in a form of a liquid droplet. That is, the liquid ejecting portion 12 drives the actuator 24 to eject the liquid in the pressure chamber 20 from the nozzle 19.

The liquid supply source 13 is, for example, an accommodation container capable of accommodating the liquid. The liquid supply source 13 may be a cartridge that replenishes the liquid by exchanging the accommodation container or may be an accommodation tank fixed to a mounting portion 26. When the liquid supply source 13 is a cartridge, the mounting portion 26 detachably holds the liquid supply source 13. At least one set of the liquid supply source 13 and the supply mechanism 14 is provided for each type of liquid ejected from the liquid ejecting portion 12. In the first embodiment, a configuration in which four sets of the liquid supply sources 13 and the supply mechanisms 14 are provided will be described as an example.

The supply mechanism 14 includes a liquid supply flow path 27 enabling a supply of the liquid from the liquid supply source 13 on the upstream to the liquid ejecting portion 12 on the downstream in a liquid supply direction A. A portion of the liquid supply flow path 27 also functions as a circulation path in cooperation with a circulation path forming portion 28. That is, the circulation path forming portion 28 connects the common liquid chamber 17 and the liquid supply flow path 27 to each other. A circulation pump 29 that circulates the liquid in a circulation direction B in the circulation path is provided in the circulation path forming portion 28.

A pressurizing mechanism 31 is provided on the liquid supply source 13 side closer than the position where the circulation path forming portion 28 is connected in the liquid supply flow path 27. The pressurizing mechanism 31 pressurizes and supplies the liquid to the liquid ejecting portion 12 by causing the liquid to flow from the liquid supply source 13 in the supply direction A. A filter unit 32, a static mixer 33, a liquid storage portion 34, and a pressure adjusting device 47 are provided in a portion of the liquid supply flow path 27, which also functions as a circulation path on the downstream of the position where the circulation path forming portion 28 is connected, in order from the upstream.

The pressurizing mechanism 31 includes a positive displacement pump 38 capable of pressurizing a predetermined amount of liquid by causing a flexible member 37 to reciprocate, and one-way valves 39 and 40 respectively provided on the upstream and the downstream of the positive displacement pump 38 in the liquid supply flow path 27. The positive displacement pump 38 includes a pump chamber 41 and a negative pressure chamber 42 which are separated by a flexible member 37. The positive displacement pump 38 further includes a pressure reducing portion 43 that reduces the pressure in the negative pressure chamber 42, and a biasing member 44 that is provided in the negative pressure chamber 42 and biases the flexible member 37 toward the pump chamber 41.

The one-way valves 39 and 40 allow the liquid to flow from the upstream to the downstream in the liquid supply flow path 27 and inhibit the liquid from flowing from the downstream to the upstream. That is, the pressurizing mechanism 31 is capable of pressurizing the liquid supplied to the pressure adjusting device 47 in a manner that the biasing member 44 biases the liquid in the pump chamber 41 through the flexible member 37. Therefore, a pressurizing force at which the pressurizing mechanism 31 pressurizes the liquid is set by a biasing force of the biasing member 44.

The filter unit 32 is provided to be capable of capturing air bubbles or foreign matters in the liquid and performing exchange. The static mixer 33 causes changes such as direction change or division, in the flow of the liquid so as to reduce the bias of the concentration in the liquid. The liquid storage portion 34 stores the liquid in a volume-variable space biased by a spring 45, and reduces fluctuations in the pressure of the liquid.

Next, the pressure adjusting device 47 will be described in detail.

As illustrated in FIG. 4, the pressure adjusting device 47 includes a pressure adjusting mechanism 35 that is provided in the liquid supply flow path 27 and constitutes a portion of the liquid supply flow path 27, and a pressing mechanism 48 that presses the pressure adjusting mechanism 35. The pressure adjusting mechanism 35 includes a main body portion 52 in which a liquid inflow portion 50 into which the liquid to be supplied from the liquid supply source 13 through the liquid supply flow path 27 flows, and a liquid outflow portion 51 capable of accommodating the liquid are formed.

The liquid supply flow path 27 and the liquid inflow portion 50 are partitioned by a wall portion 53, and communicate with each other through a through-hole 54 formed in the wall portion 53. The through-hole 54 is covered with a filter member 55. Thus, the liquid in the liquid supply flow path 27 is filtered by the filter member 55 and then flows into the liquid inflow portion 50.

At least a portion of the wall portion of the liquid outflow portion 51 is configured by a diaphragm 56. The diaphragm 56 receives the pressure of the liquid in the liquid outflow portion 51 at a first surface 56a being the inner surface of the liquid outflow portion 51, and receives the atmospheric pressure at a second surface 56b being the outer surface of the liquid outflow portion 51. Therefore, the diaphragm 56 performs displacement in accordance with the pressure inside the liquid outflow portion 51. The volume of the liquid outflow portion 51 changes by the displacement of the diaphragm 56. The liquid inflow portion 50 and the liquid outflow portion 51 communicate with each other by a communication path 57.

The pressure adjusting mechanism 35 includes an on-off valve 59 capable of switching a state between a valve closed state and a valve opened state. The valve closed state is a state where the liquid inflow portion 50 and the liquid outflow portion 51 are not in communication with each other in the communication path 57. The valve opened state is a state where the liquid inflow portion 50 and the liquid outflow portion 51 are in communication with each other. The on-off valve 59 includes a valve portion 60 capable of blocking the communication path 57 and a pressure receiving portion 61 that receives pressure from the diaphragm 56. The on-off valve 59 moves when the pressure receiving portion 61 is pressed by the diaphragm 56. That is, the pressure receiving portion 61 also functions as a moving member that is movable in a state of being in contact with the diaphragm 56 that performs displacement in a direction in which the volume of the liquid outflow portion 51 is reduced.

An upstream biasing member 62 is provided in the liquid inflow portion 50, and a downstream biasing member 63 is provided in the liquid outflow portion 51. Both the upstream biasing member 62 and the downstream biasing member 63 biases the on-off valve 59 in a direction in which the on-off valve is closed. When pressure applied to the first surface 56a is lower than pressure applied to the second surface 56b, and a difference between the pressure applied to the first surface 56a and the pressure applied to the second surface 56b is equal to or greater than a predetermined value, the on-off valve 59 turns from the valve closed state into the valve opened state. The predetermined value is set to 1000 Pa, for example.

The predetermined value is a value determined in accordance with a biasing force of the upstream biasing member 62, a biasing force of the downstream biasing member 63, a force required for causing the diaphragm 56 to perform displacement, a pressing force required for blocking the communication path 57 by the valve portion 60, pressure in the liquid inflow portion 50, which acts on the surface of the valve portion 60, and pressure in the liquid outflow portion 51. That is, the predetermined value increases as the biasing forces of the upstream biasing member 62 and the downstream biasing member 63 increase.

The biasing forces of the upstream biasing member 62 and the downstream biasing member 63 are set such that the pressure in the liquid outflow portion 51 is in a negative pressure state in a range where a meniscus can be formed at a gas-liquid interface in the nozzle 19. In this case, the gas-liquid interface is a boundary at which the liquid and the gas are in contact with each other, and the meniscus is a curved liquid surface formed in a manner that the liquid comes into contact with the nozzle 19. Preferably, a recessed meniscus suitable for ejecting the liquid is formed in the nozzle 19. The negative pressure state in a range in which the meniscus may be formed is set to −1000 Pa when the pressure applied to the second surface 56b is atmospheric pressure, for example.

In this manner, in the first embodiment, when the on-off valve 59 is closed in the pressure adjusting mechanism 35, the pressure of the liquid on the upstream of the pressure adjusting mechanism 35, specifically, the pressure of the liquid in the liquid inflow portion 50 and on the upstream of the liquid inflow portion 50 is normally set to positive pressure by the pressurizing mechanism 31. The pressure of the liquid on the downstream of the pressure adjusting mechanism 35, specifically, in the liquid outflow portion 51 and on the downstream of the liquid outflow portion 51 is normally set to negative pressure by the diaphragm 56. Thus, the pressure in the liquid ejecting portion 12 on the downstream of the liquid outflow portion 51 is normally set to negative pressure.

In the state illustrated in FIG. 4, when the liquid ejecting portion 12 ejects the liquid, the liquid accommodated in the liquid outflow portion 51 is supplied to the liquid ejecting portion 12 through the liquid supply flow path 27. Then, the pressure in the liquid outflow portion 51 decreases. When the difference between the pressure applied to the first surface 56a and the pressure applied to the second surface 56b of the diaphragm 56 becomes equal to or greater than the predetermined value, the diaphragm 56 deforms to be bent in the direction in which the volume of the liquid outflow portion 51 is reduced. When the pressure receiving portion 61 is pressed and moves by the deformation of the diaphragm 56, the on-off valve 59 is opened.

When the on-off valve 59 is opened, the liquid in the liquid inflow portion 50 is pressurized by the pressurizing mechanism 31. Thus, the liquid is supplied from the liquid inflow portion 50 to the liquid outflow portion 51, and the pressure in the liquid outflow portion 51 rises. Thus, the diaphragm 56 deforms to increase the volume of the liquid outflow portion 51. When the difference between the pressure applied to the first surface 56a of the diaphragm 56 and the pressure applied to the second surface 56b of the diaphragm 56 becomes smaller than the predetermined value, the on-off valve 59 turns from the valve opened state to the valve closed state and inhibits the flowing of the liquid.

In this manner, the pressure adjusting mechanism 35 adjusts the pressure in the liquid ejecting portion 12, which is the back pressure of the nozzle 19, by causing the diaphragm 56 to perform displacement and adjusting the pressure of the liquid to be supplied to the liquid ejecting portion 12.

As illustrated in FIG. 4, the pressing mechanism 48 includes an expansion and contraction portion 67, a pressing member 68, and a pressure adjusting portion 69. The expansion and contraction portion 67 forms a pressure adjustment chamber 66 on the second surface 56b side of the diaphragm 56. The pressing member 68 presses the expansion and contraction portion 67. The pressure adjusting portion 69 is capable of adjusting the pressure in the pressure adjustment chamber 66. The expansion and contraction portion 67 is formed of, for example, rubber or resin in a balloon shape, and expands or contracts by adjusting the pressure of the pressure adjustment chamber 66 by the pressure adjusting portion 69. The pressing member 68 has a bottomed cylindrical shape. A portion of the expansion and contraction portion 67 is inserted into an insertion hole 70 formed in the bottom of the pressing member.

The edge portion of an inner surface of the pressing member 68 on an opening portion 71 side is rounding-chamfered and rounded. The pressing member 68 forms an air chamber 72 that covers the second surface 56b of the diaphragm 56, by being attached to the pressure adjusting mechanism 35 such that the opening portion 71 is closed by the pressure adjusting mechanism 35. The pressure in the air chamber 72 is set to the atmospheric pressure, and the atmospheric pressure acts on the second surface 56b of the diaphragm 56.

That is, the pressure adjusting portion 69 expands the expansion and contraction portion 67 by adjusting the pressure in the pressure adjustment chamber 66 to pressure higher than the atmospheric pressure which is the pressure in the air chamber 72. Then, the pressing mechanism 48 presses the diaphragm 56 in the direction in which the volume of the liquid outflow portion 51 is reduced, in a manner that the pressure adjusting portion 69 expands the expansion and contraction portion 67. At this time, the expansion and contraction portion 67 of the pressing mechanism 48 presses a region of the diaphragm 56, which is in contact with the pressure receiving portion 61. The area of the region of the diaphragm 56, which is in contact with the pressure receiving portion 61 is larger than the cross-sectional area of the communication path 57.

As illustrated in FIG. 5, the pressure adjusting portion 69 includes a pressurizing pump 74 that pressurizes a fluid such as air and water, a connection path 75 that connects the pressurizing pump 74 and the expansion and contraction portion 67, a detection portion 76, and a fluid pressure adjusting portion 77. The detection portion 76 and the fluid pressure adjusting portion 77 are provided in the connection path 75. The downstream of the connection path 75 is branched into a plurality of parts, and the plurality of parts are connected to the expansion and contraction portions 67 of a plurality of pressure adjusting devices 47. In the first embodiment, a configuration in which four pressure adjusting devices 47 are provided will be described as an example. When a switch valve of switching the state of a flow path between a communication state and a non-communication state is provided in each of a plurality of branched flow paths of the connection path 75, it is possible to selectively supply the pressurized fluid to the plurality of expansion and contraction portions 67.

That is, the fluid pressurized by the pressurizing pump 74 is supplied to each of the expansion and contraction portions 67 through the connection path 75. The detection portion 76 detects the pressure of the fluid in the connection path 75, and the fluid pressure adjusting portion 77 is configured by, for example, a safety valve. When the pressure of the fluid in the connection path 75 becomes higher than predetermined pressure, the fluid pressure adjusting portion 77 automatically opens the valve to discharge the fluid in the connection path 75 to the outside, and thus decreases the pressure of the fluid in the connection path 75.

As illustrated in FIG. 5, the liquid ejecting apparatus 11 includes a control portion 160 that controls driving of various components of the liquid ejecting apparatus 11. The control portion 160 is a microcomputer including a CPU, ROM, RAM and the like.

The control portion 160 performs a printing operation of forming a character or an image on a medium 113 by alternately performing a transport operation of driving the transporting portion 114 to transport the medium 113 by a unit transport amount and an ejection operation of ejecting a liquid from the liquid ejecting portion 12 onto the medium 113 while moving the carriage 124 in the scanning direction X.

The control portion 160 drives the pressurizing pump 74 in the pressing mechanism 48 to supply the pressurized fluid to the expansion and contraction portion 67. As a result of the expansion and contraction portion 67 expanding in this manner, the diaphragm 56 performs displacement in the direction of reducing the volume of the liquid outflow portion 51, and the on-off valve 59 is opened. As described above, the control portion 160 performs a control of opening and closing the on-off valve 59, based on the driving of the pressing mechanism 48.

The control portion 160 performs a discharge operation of making the pressure of the liquid in the liquid ejecting portion 12 larger than the atmospheric pressure being the pressure outside the liquid ejecting portion 12, and thus discharging the liquid pressurized by the pressurizing mechanism 31 from the nozzle 19 of the liquid ejecting portion 12. The discharge operation is also referred to as pressurized cleaning. That is, when performing the discharge operation, the control portion 160 causes the pressing mechanism 48 to press the diaphragm 56 so as to open the on-off valve 59, and supplies the liquid pressurized by the pressurizing mechanism 31 to the pressure adjusting mechanism 35 and the liquid ejecting portion 12.

Here, after the discharge operation, the pressure in the liquid ejecting portion 12 is likely to be higher than pressure during the printing operation. Specifically, during the printing operation, the pressure in the liquid ejecting portion 12 is negative. However, after the discharge operation, the pressure in the liquid ejecting portion 12 is likely to be positive pressure higher than the atmospheric pressure.

Therefore, when the printing operation is performed after the discharge operation, the ejection of the liquid from the nozzle 19 of the liquid ejecting portion 12 may become unstable. For example, the size of the droplet ejected from the nozzle 19 of the liquid ejecting portion 12 may not be the desired size, or the liquid may not be ejected at a timing at which the liquid is to be ejected.

Thus, in the first embodiment, the control portion 160 performs a stop operation of stopping the pressing portion 144 around which the wiping member 148 is wound, for a predetermined time at a position at which the pressing portion comes into contact with a liquid that is discharged from the nozzle 19 by the discharge operation, and then swells and stays on the nozzle surface 18, or the nozzle 19, for the wiping operation performed after the discharge operation.

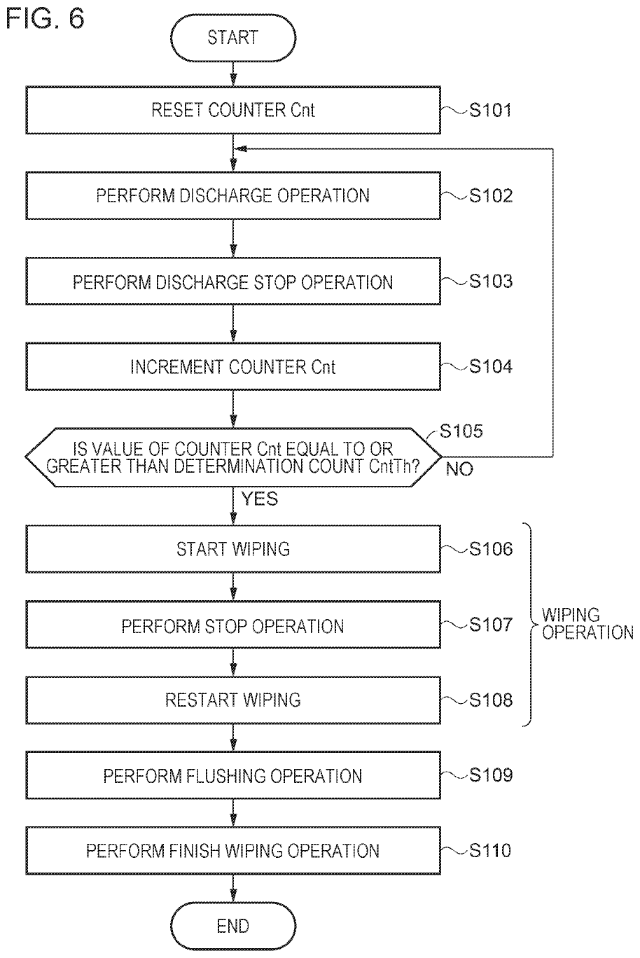

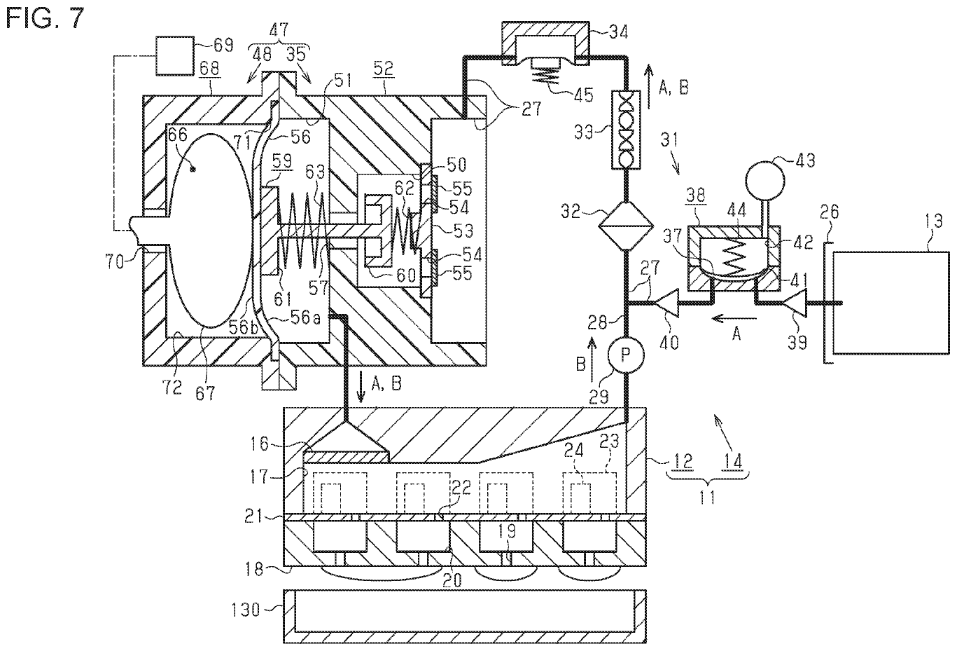

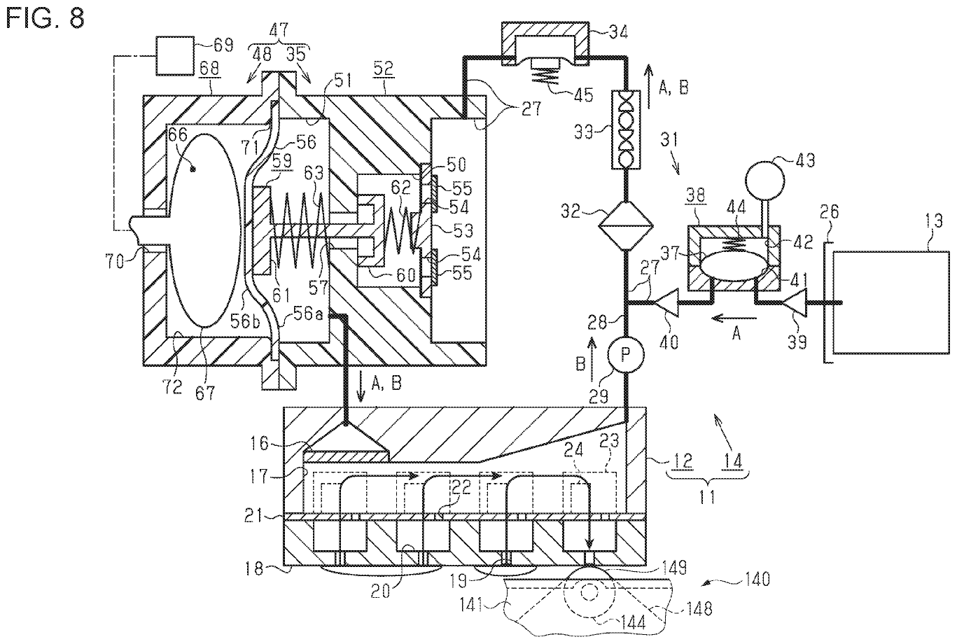

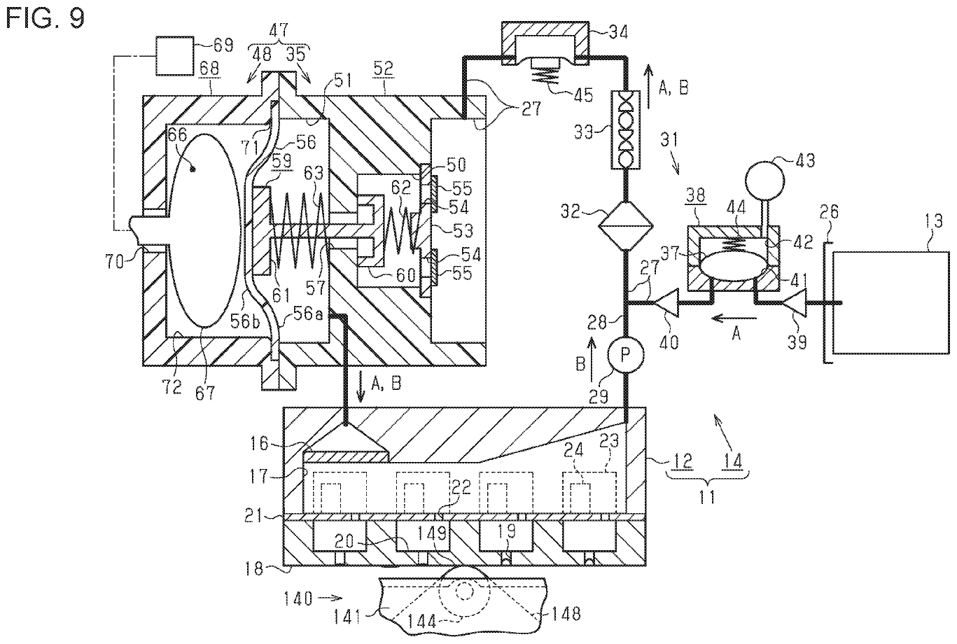

FIG. 6 is a flowchart illustrating a maintenance method. FIG. 7 is a schematic diagram illustrating the discharge operation. FIG. 8 is a schematic diagram illustrating the stop operation. FIG. 9 is a schematic diagram illustrating a finish wiping operation. Next, a maintenance method of the liquid ejecting apparatus 11 will be described with reference to FIGS. 6 to 9. The maintenance may be executed every preset control cycle, may be executed only when it is predicted that liquid ejection failure has occurred in the nozzle 19, or may be executed manually by a user of the liquid ejecting apparatus 11.

In Step S101, the control portion 160 resets a counter Cnt which is a variable for counting, to “0 (zero)”.

In Step S102, the control portion 160 performs a discharge operation of discharging the liquid from the nozzle 19. Specifically, the control portion 160 causes the nozzle surface 18 of the liquid ejecting portion 12 to face the liquid receiving portion 131. The control portion 160 controls the driving of the pressing mechanism 48 and causes the diaphragm 56 to perform displacement in the direction in which the volume of the liquid outflow portion 51 decreases, thereby opening the on-off valve 59. In this manner, the pressurized liquid flows into the liquid outflow portion 51, the liquid supply flow path 27, the common liquid chamber 17, the pressure chamber 20, and the nozzle 19, and thus the liquid is discharged from the nozzle 19. The liquid discharged from the nozzle 19 by the discharge operation swells to cover the nozzle 19.

In Step S103, the control portion 160 performs a discharge stop operation of stopping the discharge operation. Specifically, the control portion 160 controls the driving of the pressing mechanism 48 and causes the diaphragm 56 to perform displacement in the direction in which the volume of the liquid outflow portion 51 increases, thereby closing the on-off valve 59. In this manner, the pressurized liquid is not supplied to the downstream of the pressure adjusting mechanism 35. A period from the end of the discharge operation to the start of the discharge stop operation may be, for example, about 0.1 seconds to 1 second.

In Step S104, the control portion 160 increments the counter Cnt by “1”.

In Step S105, the control portion 160 determines whether or not the counter Cnt becomes equal to or greater than a defined count CntTh. Here, the defined count CntTh is a determination value for determining how many times the discharge operation and the discharge stop operation are repeated. Therefore, the defined count CntTh may be determined based on the specifications of the liquid ejecting apparatus 11 or setting of the user. When whether or not the liquid ejection failure has occurred in all the nozzles 19 of the liquid ejecting portion 12 is detected, the defined count CntTh may be determined in accordance with the number of defective nozzles in which the liquid ejection failure has occurred.

When the counter Cnt is smaller than the defined count CntTh (Step S105: NO), the control portion 160 causes the process to transition to the previous Step S102. When the counter Cnt is equal to or greater than the defined count CntTh (Step S105: YES), the control portion 160 causes the process to proceed to Step S106.

Steps S106 to S108 correspond to a wiping operation of wiping the nozzle surface 18 with the wiping member 148.

In Step S106, the control portion 160 starts the wiping operation. The control portion 160 causes the nozzle surface 18 of the liquid ejecting portion 12 to face the wiping mechanism 140. The control portion 160 drives the wiping mechanism 140 to start wiping of the nozzle surface 18 from a wiping operation start position in the transport direction Y being a first wiping direction. Thus, the liquid adhering to the nozzle surface 18 is absorbed by the wiping member 148 extending forward from the pressing portion 144 in the transport direction Y. The wiping operation start position is one end side of the nozzle surface 18 in the transport direction Y. A wiping operation end position is the other end side of the nozzle surface 18 in the wiping direction.

In Step S107, the control portion 160 performs a stop operation. Specifically, the control portion 160 stops the wiping member 148 in the wiping operation for a predetermined time at a position where the wiping member 148 comes into contact with the liquid that swells to cover the nozzle 19 or with the nozzle 19. A stop position is preferably a position at which the wiping member comes into contact with the liquid that swells to cover the nozzle 19 closer to the wiping operation start position than the wiping operation end position among the plurality of nozzles 19 forming the nozzle row 19a, or with the nozzle 19.

Preferably, the stop position is a position at which the wiping member comes into contact with the liquid that swells to cover the nozzle 19 which is closest to the wiping operation start position or with the nozzle 19. As described above, since the stop operation is performed at the position close or closest to the wiping operation start position, it is possible to start the stop operation in a state where the wiping member 148 does not collect the liquid, that is, in a state where liquid absorption capacity is high. With the stop operation, the liquid which is in contact with the wiping member 148 is collected by the wiping member 148. The liquid that swells from the other nozzle 19 without directly coming into contact with the wiping member 148 communicates with the liquid that comes into contact with the wiping member 148 through the liquid stored in the liquid ejecting portion 12. Thus, the liquid is collected in the wiping member 148 through the pressure chamber 20 or the common liquid chamber 17 by the capillary force as liquid absorbing power of the wiping member 148. The flow of the liquid collected by the stop operation is indicated by an arrow in FIG. 8. The liquid collected in the wiping member 148 permeates the wiping member 148 extending in the wiping direction side. Thus, the pressure in the liquid ejecting portion 12, which has increased by the discharge operation, decreases. At this time, the wiping member 148 is compressed between the nozzle surface 18 and the pressing portion 144, and has a high capillary force. Thus, it is possible to efficiently collect the liquid. The predetermined time for performing the stop operation is determined by the number of nozzles 19 and nozzle rows 19a, the volume of the common liquid chamber 17, the capillary force of the wiping member 148, and the like.

In Step S108, the control portion 160 restarts the wiping operation. The control portion 160 drives the wiping mechanism 140 to move the wiping member 148 from the stop position to the wiping operation end position. The control portion 160 winds the wiping member 148 that has absorbed the liquid around the winding portion 143, winds the wiping member 148 that has not absorbed the liquid around the pressing portion 144, moves the wiping mechanism 140 in a direction opposite to the transport direction Y being the second wiping direction, and then wipes the nozzle surface 18 again. Since the stop operation is performed in a series of wiping operations, the wiping operation may be restarted in a state where the liquid swelling on the nozzle surface 18 is collected through the flow path in the liquid ejecting portion.

In Step S109, the control portion 160 performs a flushing operation as the maintenance operation of the liquid ejecting portion 12. The control portion 160 causes the nozzle surface 18 of the liquid ejecting portion 12 to face the liquid receiving portion 131. The control portion 160 drives the actuator 24 to eject the liquid having a volume equal to or larger than the volume of the common liquid chamber 17.

In Step S110, the control portion 160 performs a finish wiping operation of wiping the nozzle surface 18 with the wiping mechanism 140. The control portion 160 causes the nozzle surface 18 of the liquid ejecting portion 12 to face the wiping mechanism 140 and then drives the wiping mechanism 140. With the finish wiping operation, the liquid which has not been allowed to be wiped in the wiping operation of Steps S106 to S108 is wiped. A meniscus suitable for ejecting the liquid is formed in the nozzle 19. Then, the control portion 160 temporarily ends the series of processes.

The stop operation in Step S107 may be performed a plurality of times by changing the position at which the wiping member 148 is stopped, instead of one time.

In Step S108, it has been described that the wiping member 148 is moved from the stop position to the wiping operation end position, and then wipes the nozzle surface 18 again. However, when it is not possible to sufficiently wipe the liquid by one wiping, the wiping operation may be ended without wiping the nozzle surface 18 again.

In Step S108, it has been described that the wiping member 148 is moved from the stop position to the wiping operation end position. However, after the stop operation, the wiping member may return to the wiping operation start position and be moved from the wiping operation start position to the wiping operation end position. When the wiping member 148 returns to the wiping operation start position, the wiping member 148 that has absorbed the liquid may be wound around the winding portion 143 and the wiping member 148 that has not yet absorbed the liquid may be wound around the pressing portion 144.

When it is possible to sufficiently wipe the liquid by the wiping operation in Steps S106 to S108 and a meniscus suitable for ejecting the liquid is formed in the nozzle 19, the finish wiping operation in Step S110 may be omitted.

Next, the action when the liquid ejecting apparatus 11 performs cleaning in the first embodiment will be described.

When the liquid ejecting apparatus 11 performs the printing operation, some nozzles 19 of the plurality of nozzles 19 provided in the liquid ejecting portion 12 may become defective nozzles in which liquid ejection failure has occurred. In this case, cleaning is performed to recover the liquid ejection failure of the defective nozzle.

As illustrated in FIG. 7, when cleaning is performed, the pressurizing pump 74 of the pressure adjusting portion 69 is driven, and the pressurized fluid is supplied to the expansion and contraction portion 67. Then, the expansion and contraction portion 67 to which the fluid is supplied expands and presses the region of the diaphragm 56, which is in contact with the pressure receiving portion 61, thereby opening the on-off valve 59.

That is, the pressing mechanism 48 moves the pressure receiving portion 61 against the biasing forces of the upstream biasing member 62 and the downstream biasing member 63, thereby opening the on-off valve 59. In this case, since the pressure adjusting portions 69 are connected to the expansion and contraction portions 67 of the plurality of pressure adjusting devices 47, the on-off valves 59 of all the pressure adjusting devices 47 are opened.

At this time, the diaphragm 56 is deformed in the direction in which the volume of the liquid outflow portion 51 is reduced. Thus, the liquid accommodated in the liquid outflow portion 51 is pressed to the liquid ejecting portion 12 side. That is, the pressure at which the diaphragm 56 presses on the liquid outflow portion 51 is transmitted to the liquid ejecting portion 12, and thus, the meniscus is broken and the liquid overflows from the nozzle 19. That is, the pressing mechanism 48 presses the diaphragm 56 such that the pressure in the liquid outflow portion 51 becomes higher than the pressure at which at least one meniscus is broken. For example, the pressure at which the meniscus is broken is pressure at which the liquid-side pressure at the gas-liquid interface becomes higher than the gas-side pressure by 1000 Pa.

The pressing mechanism 48 presses the diaphragm 56 to open the on-off valve 59 regardless of the pressure in the liquid inflow portion 50. In this case, the pressing mechanism 48 presses the diaphragm 56 with a pressing force larger than a pressing force generated when pressure obtained by adding the above-described predetermined value to the pressure at which the pressurizing mechanism 31 pressurizes the liquid is applied to the diaphragm 56.

Then, in the state where the on-off valve 59 is opened, the liquid pressurized by the pressurizing mechanism 31 is supplied to the liquid ejecting portion 12 by regularly driving the pressure reducing portion 43. That is, when the pressure in the negative pressure chamber 42 is reduced by driving of the pressure reducing portion 43, the flexible member 37 moves in the direction in which the volume of the pump chamber 41 is increased.

Then, the liquid flows from the liquid supply source 13 into the pump chamber 41. When the pressure reduction by the pressure reducing portion 43 is released, the flexible member 37 is biased by the biasing force of the biasing member 44 in the direction in which the volume of the pump chamber 41 is decreased. That is, the liquid in the pump chamber 41 is pressurized by the biasing force of the biasing member 44 through the flexible member 37, passes through the downstream one-way valve 40, and is supplied to the downstream of the liquid supply flow path 27.

The valve opened state of the on-off valve 59 is maintained during a period in which the pressing mechanism 48 presses the diaphragm 56. Thus, when the pressurizing mechanism 31 pressurizes the liquid in this state, the discharge operation of discharging the liquid from the nozzle 19 by the pressurizing force being transmitted to the liquid ejecting portion 12 through the liquid inflow portion 50, the communication path 57, and the liquid outflow portion 51 is performed. As illustrated in FIG. 7, preferably, when the discharge operation is performed, the carriage 124 is moved such that the liquid ejecting portion 12 faces the liquid receiving portion 131 to receive the liquid discharged to the liquid receiving portion 131.

Then, the discharge stop operation of stopping the discharge operation is performed. In the discharge stop operation, the pressing of the pressing mechanism 48 on the diaphragm 56 is released, and the on-off valve 59 is closed. Thus, the upstream and the downstream of the pressure adjusting mechanism 35 do not communicate with each other, and thus the pressurized liquid is not supplied from the liquid supply source 13 to the liquid ejecting portion 12. In the first embodiment, the discharge operation and the discharge stop operation are repeated in a short cycle. Thus, in the discharge operation, the decrease in the flow velocity of the liquid flowing in the liquid supply flow path 27 and the liquid ejecting portion 12 is suppressed, and it is easy to remove foreign matters such as air bubbles from the liquid supply flow path 27 and the liquid ejecting portion 12.

Immediately after the discharge stop operation is performed, the pressure in the liquid ejecting portion 12 disposed on the downstream of the pressure adjusting mechanism 35 is high, and the pressure is not suitable for the printing operation. Thus, in order to decrease the pressure of the liquid ejecting portion 12, in the wiping operation, the stop operation of stopping the wiping member 148 for a predetermined time at a position at which the wiping member comes into contact with the liquid or the nozzle 19 is performed.

Immediately after the discharge stop operation is performed, the liquid is continuously dropped from the nozzle 19, and the liquid is continuously discharged from the nozzle 19. The discharge of the liquid from the nozzle 19 is continuously performed until the pressure in the liquid ejecting portion 12 decreases. At this time, the liquid that swells to cover the nozzle 19 adheres to the nozzle surface 18.

As illustrated in FIG. 8, in the wiping operation, the carriage 124 is moved such that the liquid ejecting portion 12 faces the wiping mechanism 140, and the wiping member 148 is stopped for a predetermined time at a position at which the wiping member comes into contact with the liquid that swells to cover the nozzle 19 or with the nozzle 19, by the stop operation. FIG. 8 illustrates a case where the wiping member 148 comes into contact with the nozzle 19 closest to the wiping operation start position. With the stop operation, the liquid swelling from each nozzle 19 is collected in the wiping member 148 from the nozzle 19 in contact with the wiping member 148, through the pressure chamber 20 of the nozzle 19 and the common liquid chamber 17.

More specifically, there is a relation of the meniscus pressure resistance when a recessed meniscus is formed on the liquid side of the nozzle 19> the capillary force of the wiping member 148> a distance from the gravity center of the swelling liquid to the nozzle surface 18. The meniscus pressure resistance here means a pressure difference between the liquid side and the gas side, which may withstand without being broken, when the liquid side formed in the nozzle 19 causes pressure lower than pressure on the gas side to act on the recessed meniscus from the liquid side. In the first embodiment, the meniscus pressure resistance is 3000 to 5000 Pa and this corresponds to 300 to 500 mm in terms of water level. The capillary force is about 1000 Pa, and this corresponds to 100 mm in terms of water level. The distance from the gravity center of the swelling liquid to the nozzle surface 18 is smaller than 5 mm. From this relation, the stop operation is performed at a position which comes into contact with the liquid that swells to cover the nozzle 19 or with the nozzle 19, and thus it is possible to collect the liquid that covers the nozzle 19, from the nozzle 19 in contact with the wiping member 148 to the wiping member 148 without sucking the air from the nozzle 19 into the nozzle 19. Accordingly, the pressure in the liquid ejecting portion 12 is decreased. As illustrated in FIG. 8, the stop operation may be performed in a state where the nozzle 19 and the wiping member 148 are in contact with each other, or in a state where the liquid swelling from the nozzle 19 and the wiping member 148 are in contact with each other.

In the first embodiment, the flushing operation is performed after the wiping operation is completed. In the flushing operation, the liquid having a volume equal to or larger than the volume of the common liquid chamber 17 is ejected from the nozzle 19. With the flushing operation, the liquid staying in the common liquid chamber 17 is replaced with a new liquid supplied from the pressure adjusting device 47 at the end of the stop operation.

When the flushing operation is completed, the finish wiping operation is performed. As illustrated in FIG. 9, in the finish wiping operation, wiping is performed in a state where the wiping portion 149 of the wiping member 148 is brought into contact with the nozzle surface 18 of the liquid ejecting portion 12. In this manner, the liquid adhering to the nozzle surface 18 of the liquid ejecting portion 12 is removed, and a normal meniscus is formed in the nozzle 19 of the liquid ejecting portion 12.

Next, a method of manufacturing the pressure adjusting device 47 in the first embodiment will be described.

Firstly, the main body portion 52 in the first embodiment is formed of light absorbing resin that absorbs laser light and generates heat, or resin that is colored with a dye that absorbs light. Examples of the light absorbing resin include polypropylene and polybutylene terephthalate. The diaphragm 56 is formed by laminating different materials such as polypropylene and polyethylene terephthalate, and has flexibility and transparency for transmitting laser light. The pressing member 68 is formed of light transmissive resin that transmits laser light. Examples of the light transmissive resin include polystyrene and polycarbonate. The degree of the transparency of the diaphragm 56 is higher than that of the main body portion 52 and is lower than that of the pressing member 68.

As illustrated in FIG. 4, firstly, the diaphragm 56 is nipped by the pressing member 68 in which a portion of the expansion and contraction portion 67 is inserted into the insertion hole 70, and the main body portion 52. Irradiation with laser light is performed through the pressing member 68. Then, the main body portion 52 absorbs the laser light transmitted through the pressing member 68 and generates heat. With the heat generated at this time, the main body portion 52, the diaphragm 56, and the pressing member 68 are welded. Thus, the pressing member 68 also functions as a jig for pressing the diaphragm 56 when the pressure adjusting device 47 is manufactured.

As described above, according to the liquid ejecting apparatus 11 and the maintenance method of the liquid ejecting apparatus 11 according to the first embodiment, it is possible to obtain effects as follows.

After the discharge operation, the control portion 160 in the liquid ejecting apparatus 11 performs the stop operation of stopping the wiping member 148 for a predetermined time at a position where the wiping member 148 comes into contact with the liquid that swells to cover the nozzle 19 or with the nozzle 19. Thus, the swelling liquid or the liquid in the liquid ejecting portion 12 is collected in the wiping member 148 through the pressure chamber 20 or the common liquid chamber 17, and thus the pressure in the liquid ejecting portion 12, which has increased, is decreased by the discharge operation. Accordingly, the ejection of the liquid from the nozzle 19 is stable.

The control portion 160 performs the stop operation at a position closer to the wiping operation start position than the wiping operation end position. The wiping member 148 at the position close to the wiping operation start position is in a state where liquid absorption power is high. Thus, it is possible to efficiently collect the liquid.

The control portion 160 performs the stop operation at the position closest to the wiping operation start position. The wiping member 148 at the position closest to the wiping operation start position is in a state where the liquid absorption power is high. Thus, it is possible to collect the liquid more with high efficiency.

After the wiping operation, the control portion 160 performs a flushing operation of ejecting the liquid having a volume equal to or larger than the volume of the common liquid chamber 17. Even though foreign matters and the like on the nozzle surface 18 are attracted into the liquid ejecting portion 12 together with the liquid swelling from each nozzle 19 by the stop operation, it is possible to discharge the foreign matters from the nozzle 19 along with the ejected liquid by the flushing operation.

In the maintenance method of the liquid ejecting apparatus 11, after the discharge operation, the stop operation of stopping the wiping member 148 for a predetermined time at a position where the wiping member 148 comes into contact with the liquid that swells to cover the nozzle 19 or with the nozzle 19 is performed. Thus, the swelling liquid or the liquid in the liquid ejecting portion 12 is collected in the wiping member 148 through the pressure chamber 20 or the common liquid chamber 17, and thus the pressure in the liquid ejecting portion 12, which has increased, is decreased by the discharge operation. Accordingly, the ejection of the liquid from the nozzle 19 is stable.

In the maintenance method of the liquid ejecting apparatus 11, the stop operation is performed at the position closer to the wiping operation start position than the wiping operation end position. The wiping member 148 at the position close to the wiping operation start position is in a state where liquid absorption power is high. Thus, it is possible to efficiently collect the liquid.

In the maintenance method of the liquid ejecting apparatus 11, the stop operation is performed at the position closest to the wiping operation start position. The wiping member 148 at the position closest to the wiping operation start position is in a state where the liquid absorption power is high. Thus, it is possible to collect the liquid more with high efficiency.

In the maintenance method of the liquid ejecting apparatus 11, after the wiping operation, the flushing operation of ejecting the liquid having a volume equal to or larger than the common liquid chamber 17 is performed. Even though foreign matters and the like on the nozzle surface 18 are attracted into the liquid ejecting portion 12 together with the liquid swelling from each nozzle 19 by the stop operation, the foreign matters are discharged from the nozzle 19 along with the ejected liquid by the flushing operation.

### 2. Second Embodiment

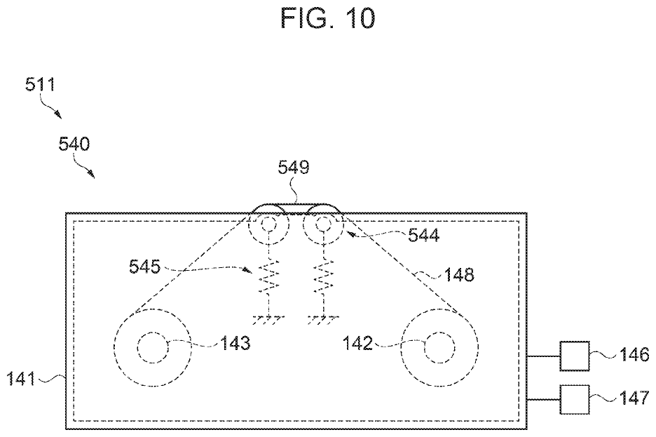

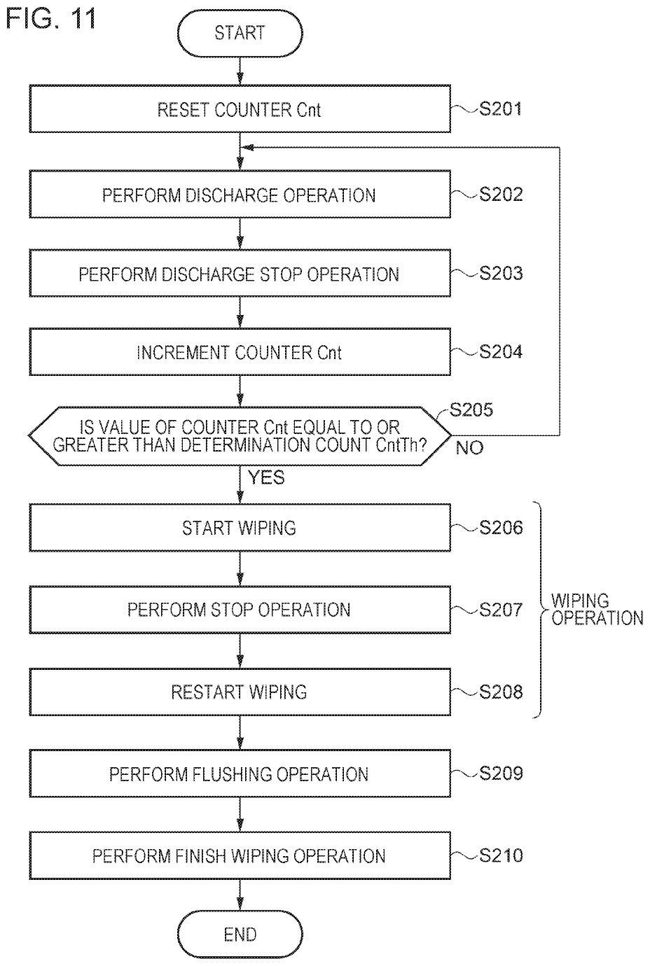

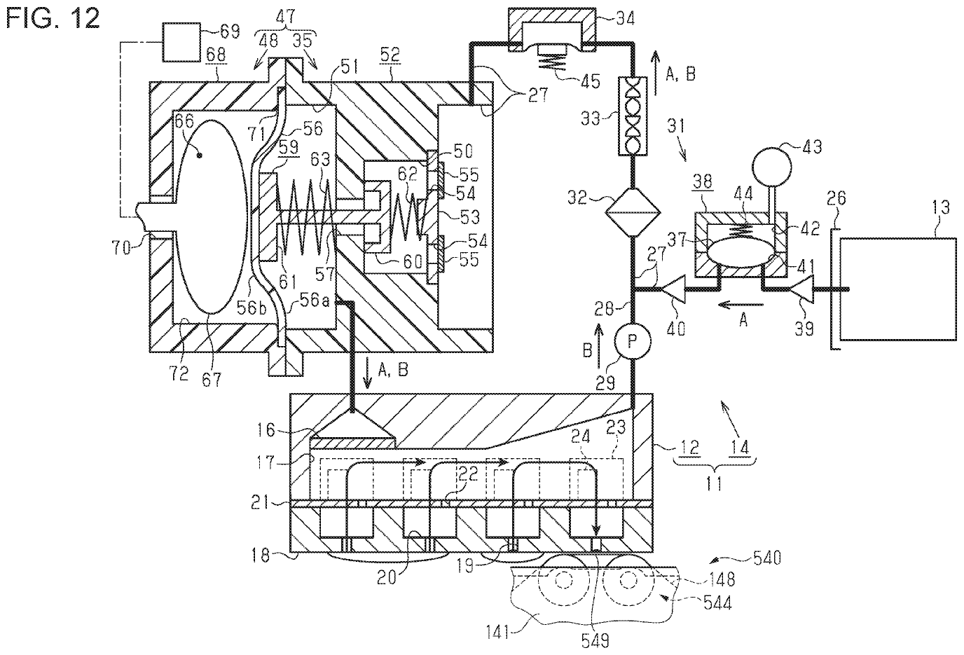

FIG. 10 is a side view illustrating a wiping mechanism of a liquid ejecting apparatus according to a second embodiment. FIG. 11 is a flowchart illustrating a maintenance method. FIG. 12 is a schematic diagram illustrating a stop operation. Next, a configuration of a liquid ejecting apparatus 511 and a maintenance method will be described with reference to FIGS. 10 to 12. The liquid ejecting apparatus 511 is obtained by changing the wiping mechanism 140 in the first embodiment to a wiping mechanism 540 illustrated in FIG. 10. The same components as those in the first embodiment are denoted by the same reference signs and repetitive description thereof will be omitted.

As illustrated in FIG. 10, the wiping mechanism 540 includes a wiping member 148 having absorptivity for absorbing a liquid, and is configured to enable wiping of the nozzle surface 18 of the liquid ejecting portion 12 in a wiping direction in a wiping operation. The wiping mechanism 540 has a box-like housing 141. In the housing 141, a pair of pressing portions 544 and a pair of pressing portions 545 are provided. The pair of pressing portions 544 press the band-like wiping member 148 located between the unwinding portion 142 and the winding portion 143, toward the nozzle surface 18. The pair of pressing members 545 apply a pressing force to the pair of pressing portions 544. The pair of pressing portions 544 is a roller pair that are rotatably supported such that the axial directions thereof are the same as the unwinding portion 142 and the winding portion 143. The pair of pressing portions 544 are disposed to be arranged at intervals in the wiping direction in the wiping operation. A portion of the pair of pressing portions 544 is exposed from an opening of the housing 141. Although the pair of pressing portions 544 has been described as rollers, the pair of pressing portions 544 may be rubber protrusion members or resin members such as urethane capable of pressing the nozzle surface 18.

In this manner, in the wiping mechanism 540, the wiping member 148 fed from the unwinding portion 142 is wound around the pair of pressing portions 544 and is wound around the winding portion 143. Thus, if the first wiper driving portion 146 and the second wiper driving portion 147 are driven in a state in which the carriage 124 is moved such that the liquid ejecting portion 12 is located above the wiping mechanism 540, the nozzle surface 18 is wiped by moving the wiping portion 549 wound around the pair of pressing portions 544 in the wiping member 148 relative to the liquid ejecting portion 12. After the wiping portion 549 absorbs the liquid by wiping the nozzle surface 18, a portion of the wiping member 148, that absorbs the liquid, is wound by driving and rotating the winding portion 143. In this manner, the wiping member 148 having the wiping portion 549 that has absorbed the liquid is replaced with a wiping member 148 in which the liquid is not absorbed.

Next, the maintenance method of the liquid ejecting apparatus 511 will be described with reference to the flowchart illustrated in FIG. 11. Steps S201 to S205 and S209 in the second embodiment are the same as Steps S101 to S105 and S109 described in the first embodiment, and description thereof will not be repeated.

Steps S206 to S208 correspond to a wiping operation of wiping the nozzle surface 18 with the wiping member 148.

In Step S206, the control portion 160 starts the wiping operation. The control portion 160 causes the nozzle surface 18 of the liquid ejecting portion 12 to face the wiping mechanism 540. The control portion 160 drives the wiping mechanism 540 to start wiping of the nozzle surface 18 from a wiping operation start position in the transport direction Y being a first wiping direction. Thus, the liquid adhering to the nozzle surface 18 is absorbed by the wiping member 148 extending forward in the transport direction Y, from the rollers located on the transport direction Y side of the pair of pressing portions 544.

In Step S207, the control portion 160 performs a stop operation. Specifically, the control portion 160 stops the wiping member 148 located between the pair of pressing portions 544 in the wiping operation for a predetermined time at a position where the wiping member 148 comes into contact with the liquid that swells to cover the nozzle 19 or with the nozzle 19. The stop position is preferably a position where the rollers being the pair of pressing portions 544 do not block the nozzle 19.

With the stop operation, the liquid in contact with the wiping member 148 is collected by the wiping member 148 located between the pair of pressing portions 544. The liquid that does not directly come into contact with the wiping member 148 communicates with the liquid that comes into contact with the wiping member 148 through the liquid stored in the liquid ejecting portion 12. Thus, the liquid is collected by the wiping member 148 located between the pair of pressing portions 544, through the pressure chamber 20 or the common liquid chamber 17 by the capillary force as liquid absorbing power of the wiping member 148. The flow of the liquid collected by the stop operation is indicated by an arrow in FIG. 12. Since the wiping member 148 is wound around the pair of pressing portions 544 is in a state where liquid accommodation capacity is high. Thus, it is possible to accommodate a large amount of liquid. The liquid collected by the wiping member 148 located between the pair of pressing portions 544 permeates the wiping member 148 extending forward in the transport direction Y side from the rollers located on the transport direction Y side of the pair of pressing portions 544. Thus, the pressure in the liquid ejecting portion 12, which has increased by the discharge operation, decreases.

In Step S208, the control portion 160 restarts the wiping operation. The control portion 160 drives the wiping mechanism 540 to move the wiping member 148 from the stop position to the end position of the wiping operation. At this time, the liquid remaining on the nozzle surface 18 is absorbed by the wiping member 148 extending forward in the transport direction Y from the rollers located on the transport direction Y side of the pair of pressing portions 544. Then, the control portion 160 moves the wiping mechanism 540 in a direction opposite to the transport direction Y, which is the second wiping direction, and wipes the nozzle surface 18 again. Since the liquid is not absorbed by the wiping member 148 that extends forward from the rollers located in the direction opposite to the transport direction Y of the pair of pressing portions 544, in the direction opposite to the transport direction Y, it is possible to perform wiping again without winding the wiping member 148.

In Step S210, the control portion 160 performs a finish wiping operation of wiping the nozzle surface 18 with the wiping mechanism 540. The control portion 160 causes the nozzle surface 18 of the liquid ejecting portion 12 to face the wiping mechanism 540 and then drives the wiping mechanism 540. With the finish wiping operation, a meniscus suitable for ejecting the liquid is formed in the nozzle 19. Then, the control portion 160 temporarily ends the series of processes.

As described above, according to the liquid ejecting apparatus 511 according to the second embodiment, it is possible to obtain effects as follows.

The liquid ejecting apparatus 511 includes the wiping mechanism 540 having a pair of pressing portions 544. After the discharge operation, the control portion 160 in the liquid ejecting apparatus 511 performs the stop operation of stopping the wiping member 148 wound around the pair of pressing portions 544, for a predetermined time at a position where the wiping member 148 comes into contact with the liquid that swells to cover the nozzle 19 or with the nozzle 19. The wiping member 148 wound around the pair of pressing portions 544 is in a state where liquid accommodation capacity is high. Thus, it is possible to collect a large amount of liquid.

The second embodiment may be modified and implemented as follows. The second embodiment and the following modification examples may be implemented in combination with each other in a range without technical contradiction.

In the flowchart illustrated in FIGS. 6 and 11, the control portion 160 may perform flushing after performing the finish wiping operation. According to this, it is possible to easily form a normal meniscus in the nozzle 19 of the liquid ejecting portion 12.

When the wiping portion 149 is brought into contact with the nozzle surface 18 to perform the wiping operation including the stop operation, a contact force of the wiping portion 149 with the nozzle surface 18 in the wiping operation and the finish wiping operation may be changed appropriately. For example, the contact force of the wiping portion with the nozzle surface 18 may be equal in a pre-wiping operation and the finish wiping operation, or the contact force in the wiping operation may be stronger.

The liquid receiving portion 131 may be provided vertically above the housing 141 of the wiping mechanism 140. According to this, after the discharge operation, it is possible to perform a pressure decrease operation without moving the carriage 124 (liquid ejecting portion 12). Therefore, it is possible to suppress leakage of the pressurized liquid from the nozzle 19 of the liquid ejecting portion 12 by the vibration acting on the liquid ejecting portion 12 during movement of the carriage 124 (liquid ejecting portion 12).

The liquid receiving portion 131 may be configured by a movable belt that is capable of receiving the liquid. In this case, in the belt, it is preferable to provide a component such as a motor for driving the belt, such that the portion at which the liquid is received may be changed to a portion at which the liquid is not received.

The pressing mechanism 48 may press the diaphragm 56 by adjusting the pressure of the air chamber 72 without providing the expansion and contraction portion 67. Specifically, the pressing mechanism 48 performs displacement of the diaphragm 56 in the direction in which the volume of the liquid outflow portion 51 becomes smaller by increasing the pressure of the air chamber 72, and performs displacement of the diaphragm 56 in the direction in which the volume of the liquid outflow portion 51 increases by decreasing the pressure in the air chamber 72. When such a configuration is adopted, the pressure in the liquid ejecting portion 12 may be reduced by setting the pressure of the air chamber 72 to negative pressure smaller than the atmospheric pressure, as a pressure reducing operation.

A buffer tank into and from which the liquid flows may be provided between the pressure adjusting mechanism 35 and the liquid ejecting portion 12 without including the pressing mechanism 48. A portion of a wall portion of the buffer tank may be set to a flexible wall which is elastically deformable, and a displacement mechanism causing the flexible wall to change the volume of the buffer tank to perform displacement may be provided. According to this configuration, it is possible to perform the discharge operation by reducing the volume of the buffer tank.

The liquid ejecting apparatus 11 may be a liquid ejecting apparatus that ejects or discharges a liquid other than an ink. The state of the liquid ejected from the liquid ejecting apparatus in the form of a minute amount of droplets includes granular, tear-like, and thread-like droplets. The liquid here may be any material that may be ejected from the liquid ejecting apparatus. For example, the liquid may be in a state when the substance is in a liquid phase. It is assumed that the liquid includes a liquid material having high or low viscosity and a fluid material such as sol, gel water, other inorganic solvents, an organic solvent, a solution, liquid resin, and liquid metal (metal melt). The liquid includes not only a liquid as one state of a substance but also a liquid in which particles of a functional material made of a solid material such as a pigment or metal particles are dissolved, dispersed or mixed in a solvent. Representative examples of the liquid include liquid crystals and various liquid compositions such as water-based inks, non-water-based inks, oil-based inks, gel inks, and hot-melt inks as described in the above embodiment. Specific examples of the liquid ejecting apparatus include, for example, a liquid ejecting apparatus that ejects a liquid containing a material such as an electrode material or a color material used in manufacturing of a liquid crystal display, an EL (electroluminescence) display, a surface emitting display, a color filter, and the like in a dispersed or dissolved state. A liquid ejecting apparatus that ejects a bioorganic substance used in biochip manufacturing, a liquid ejecting apparatus that ejects a liquid as a sample used by a precision pipette, a textile printing apparatus, a micro dispenser, or the like may be provided. A liquid ejecting apparatus that ejects lubricating oil into a precision machine such as a clock or a camera at a pinpoint and a liquid ejecting apparatus that ejects a transparent resin liquid such as ultraviolet curable resin for forming a micro hemispherical lens used for an optical communication element, an optical lens, and the like, onto a substrate may be provided. A liquid ejecting apparatus that ejects an etching liquid such as acid or alkali in order to etch a substrate and the like may be provided.

The contents obtained from the embodiment will be described below.

A liquid ejecting apparatus includes a liquid ejecting portion that is configured to eject a liquid supplied through a common flow path, from a plurality of nozzles that are arranged on a nozzle surface and form a nozzle row, a wiping mechanism that includes a wiping member and is configured to wipe the nozzle surface, and a control portion that drives the wiping mechanism during a wiping operation of wiping the nozzle surface by the wiping member or before the wiping operation after a discharge operation of discharging the liquid from the nozzle, and performs a stop operation of stopping the wiping member for a predetermined time at a position at which the wiping member comes into contact with the liquid that swells to cover the nozzle or with the nozzle.

According to this configuration, the liquid ejecting apparatus performs the stop operation of stopping the wiping member for a predetermined time after the discharge operation. Thus, the swelling liquid or the liquid in the liquid ejecting portion is collected in the wiping member through the common flow path, and thus the pressure in the liquid ejecting portion, which has increased, is decreased by the discharge operation. Accordingly, the ejection of the liquid from the nozzle is stable.

In the liquid ejecting apparatus, preferably, the wiping mechanism includes a pair of pressing portions that are arranged to be spaced in a wiping direction and press the wiping member having a band shape and being located between a unwinding portion and a winding portion toward the nozzle surface, in the wiping operation, and, in the stop operation, the wiping member located between the pair of pressing portions comes into contact with the swelling liquid or the nozzle.

According to this configuration, since the wiping member located between the pair of pressing portions is in a state where liquid accommodation capacity is high. Thus, it is possible to collect a large amount of liquid.

In the liquid ejecting apparatus, preferably, in the stop operation, the control portion stops the wiping member for a predetermined time at a position at which the wiping member comes into contact with the liquid that swells to cover the nozzle closer to a wiping operation start position than a wiping operation end position or with the nozzle among the plurality of nozzles forming the nozzle row.

According to this configuration, since the wiping member at the position close to the wiping operation start position has high liquid absorbing power, it is possible to efficiently collect the liquid by performing the stop operation at the position close to the wiping operation start position.

In the liquid ejecting apparatus, preferably, in the stop operation, the control portion stops the wiping member for a predetermined time at a position at which the wiping member comes into contact with the liquid that swells to cover the nozzle which is closest to the wiping operation start position or with the nozzle among the plurality of nozzles forming the nozzle row.

According to this configuration, since the wiping member at the position closest to the wiping operation start position has the highest liquid absorbing power, it is possible to more efficiently collect the liquid by performing the stop operation at the position close to the wiping operation start position.

In the liquid ejecting apparatus, preferably, the liquid ejecting portion includes a common liquid chamber in which the plurality of nozzles forming the nozzle row communicate with each other, as the common flow path, and drives an actuator to eject the liquid in a liquid chamber provided between the nozzle and the common liquid chamber, from the nozzle, and the control portion drives the actuator as a maintenance operation of the liquid ejecting portion, after the wiping operation, to eject the liquid having a volume equal to or larger than a volume of the common liquid chamber.

According to this configuration, even though foreign matters and the like on the nozzle surface are attracted into the liquid ejecting portion together with the liquid swelling from each nozzle by the stop operation, it is possible to discharge the foreign matters from the nozzle along with the ejected liquid by the maintenance operation.

A maintenance method of a liquid ejecting apparatus including a liquid ejecting portion that is configured to eject a liquid supplied through a common flow path, from a plurality of nozzles that are arranged on a nozzle surface and form a nozzle row, and a wiping member that is configured to wipe the nozzle surface, the method includes performing a stop operation of stopping the wiping member for a predetermined time at a position at which the wiping member comes into contact with the liquid that swells to cover the nozzle or with the nozzle, during a wiping operation of wiping the nozzle surface by the wiping member or before the wiping operation after a discharge operation of discharging the liquid from the nozzle.

According to this method, the liquid ejecting apparatus performs the stop operation of stopping the wiping member for a predetermined time after the discharge operation. Thus, the swelling liquid or the liquid in the liquid ejecting portion is collected in the wiping member through the common flow path, and thus the pressure in the liquid ejecting portion, which has increased, is decreased by the discharge operation. Accordingly, the ejection of the liquid from the nozzle is stable.

In the maintenance method of the liquid ejecting apparatus, preferably, in the stop operation, the wiping member is stopped for a predetermined time at a position at which the wiping member comes into contact with the liquid that swells to cover the nozzle closer to a wiping operation start position than a wiping operation end position or with the nozzle among the plurality of nozzles forming the nozzle row.

According to this method, since the wiping member at the position close to the wiping operation start position has high liquid absorbing power, it is possible to efficiently collect the liquid by performing the stop operation at the position close to the wiping operation start position.

In the maintenance method of the liquid ejecting apparatus, preferably, in the stop operation, the wiping member is stopped for a predetermined time at a position at which the wiping member comes into contact with the liquid that swells to cover the nozzle which is closest to the wiping operation start position or with the nozzle among the plurality of nozzles forming the nozzle row.

According to this method, since the wiping member at the position closest to the wiping operation start position has the highest liquid absorbing power, it is possible to more efficiently collect the liquid by performing the stop operation at the position close to the wiping operation start position.

In the maintenance method of the liquid ejecting apparatus, preferably, the liquid ejecting portion includes a common liquid chamber in which the plurality of nozzles forming the nozzle row communicate with each other, as the common flow path, drives an actuator to eject the liquid in a liquid chamber provided between the nozzle and the common liquid chamber, from the nozzle. Preferably, as the maintenance operation of the liquid ejecting portion, after the wiping operation, the actuator is driven to eject the liquid having a volume equal to or larger than a volume of the common liquid chamber.

According to this method, even though foreign matters and the like on the nozzle surface are attracted into the liquid ejecting portion together with the liquid swelling from each nozzle by the stop operation, it is possible to discharge the foreign matters from the nozzle along with the ejected liquid by the maintenance operation.

What is claimed is:

1. A liquid ejecting apparatus comprising:
a liquid ejecting portion configured to eject a liquid supplied through a common flow path, from a plurality of nozzles that are arranged on a nozzle surface and form a nozzle row;
a wiping mechanism that includes a wiping member and is configured to wipe the nozzle surface; and
a control portion that drives the wiping mechanism during a wiping operation of wiping the nozzle surface by the wiping member or before the wiping operation after a discharge operation of discharging the liquid from the nozzle, and performs a stop operation of stopping the wiping member for a predetermined time at a position at which the wiping member comes into contact with the liquid that swells to cover the nozzle or with the nozzle.

2. The liquid ejecting apparatus according to claim 1, wherein
the wiping mechanism includes a pair of pressing portions that are arranged to be spaced in a wiping direction and press the wiping member having a band shape and being located between a unwinding portion and a winding portion toward the nozzle surface, in the wiping operation, and
in the stop operation, the wiping member located between the pair of pressing portions comes into contact with the swelling liquid or the nozzle.

3. The liquid ejecting apparatus according to claim 1, wherein
in the stop operation, the control portion stops the wiping member for a predetermined time at a position at which the wiping member comes into contact with the liquid that swells to cover the nozzle closer to a wiping operation start position than a wiping operation end position or with the nozzle among the plurality of nozzles forming the nozzle row.

4. The liquid ejecting apparatus according to claim 3, wherein in the stop operation, the control portion stops the wiping
member for a predetermined time at a position at which the wiping member comes into contact with the liquid that swells to cover the nozzle which is closest to the wiping operation start position or with the nozzle among the plurality of nozzles forming the nozzle row.

5. The liquid ejecting apparatus according to claim 1, wherein
the liquid ejecting portion includes a common liquid chamber communicating with the plurality of nozzles forming the nozzle row, as the common flow path, and
the control portion drives an actuator as a maintenance operation of the liquid ejecting portion, after the wiping operation, to eject the liquid having a volume equal to or larger than a volume of the common liquid chamber.

6. A maintenance method of a liquid ejecting apparatus including
a liquid ejecting portion configured to eject a liquid supplied through a common flow path, from a plurality of nozzles that are arranged on a nozzle surface and form a nozzle row, and
a wiping member configured to wipe the nozzle surface, the method comprising:
performing a stop operation of stopping the wiping member for a predetermined time at a position at which the wiping member comes into contact with the liquid that swells to cover the nozzle or with the nozzle, during a wiping operation of wiping the nozzle surface by the wiping member or before the wiping operation after a discharge operation of discharging the liquid from the nozzle.

7. The maintenance method of a liquid ejecting apparatus according to claim 6, wherein
in the stop operation, the wiping member is stopped for a predetermined time at a position at which the wiping member comes into contact with the liquid that swells to cover the nozzle closer to a wiping operation start position than a wiping operation end position or with the nozzle among the plurality of nozzles forming the nozzle row.

8. The maintenance method of a liquid ejecting apparatus according to claim 7, wherein
in the stop operation, the wiping member is stopped for a predetermined time at a position at which the wiping member comes into contact with the liquid that swells to cover the nozzle which is closest to the wiping operation start position or with the nozzle among the plurality of nozzles forming the nozzle row.

9. The maintenance method of a liquid ejecting apparatus according to claim 6, wherein
the liquid ejecting portion includes a common liquid chamber communicating with the plurality of nozzles forming the nozzle row, as the common flow path, and
an actuator is driven as a maintenance operation of the liquid ejecting portion, after the wiping operation, to eject the liquid having a volume equal to or larger than a volume of the common liquid chamber.
